(19) United States
(12) Patent Application Publication
(10) Pub. No.: US 2025/0301381 A1
(43) Pub. Date: Sep. 25, 2025

(54) METHOD AND APPARATUS FOR CONDITIONAL LOWER LAYER TRIGGERED MOBILITY PROCEDURE

(71) Applicant: Wistron NeWeb Corp., Hsinchu (TW)

(72) Inventor: Hung-Chen CHEN, Hsinchu (TW)

(21) Appl. No.: 19/083,990

(22) Filed: Mar. 19, 2025

Related U.S. Application Data
(60) Provisional application No. 63/567,479, filed on Mar. 20, 2024.

(51) Int. Cl. H04W 36/08; H04W 36/36; H04W 56/00

(52) U.S. Cl. CPC H04W 36/08; H04W 36/362; H04W 56/0045

(57) ABSTRACT

A method for a conditional Layer 1/Layer 2 (L1/L2) triggered mobility (LTM) procedure is provided. The method is implemented by a user equipment (UE) and includes receiving a conditional LTM command from a source base station (BS), wherein the conditional LTM command includes a first target cell configuration of a first target cell and an execution condition. The method includes receiving a first Medium Access Control (MAC) Control Element (CE) associated with the first target cell from the source BS, wherein the first MAC CE includes Timing Advance (TA)-related information. The method includes switching to the first target cell by applying the first target cell configuration and the received TA-related information when the execution condition is fulfilled.

### CROSS REFERENCE TO RELATED APPLICATIONS

This application claims the benefit of U.S. Provisional Application No. 63/567,479, entitled “Method and Apparatus for Conditional Lower Layer Triggered Mobility”, filed on Mar. 20, 2024, the entirety of which is incorporated by reference herein.

### BACKGROUND OF THE INVENTION

### Field of the Invention

The present disclosure generally relates to wireless communication. More specifically, aspects of the present disclosure relate to a method and apparatus for a conditional Layer 1/Layer 2 (L1/L2) triggered mobility (LTM) procedure.

### Description of the Related Art

Unless otherwise indicated herein, approaches described in this section are not prior art to the claims listed below and are not admitted as prior art by inclusion in this section.

A conventional handover (HO) procedure (i.e., Layer 3/L3 mobility) is introduced to HO User Equipment (UE) from a source serving cell to a target serving cell, e.g., when the UE moves from the coverage area of the source serving cell to the coverage area of the target serving cell. The decision to perform a conventional HO is made by a current serving gNB (or the source gNB) of the current serving cell (or source cell) based on measurement results reported from a UE. If the source gNB determines that a handover is necessary, the source gNB sends an HO request message to the target gNB to ask for the HO admission. If the target gNB accepts the HO request, it replies with an HO request acknowledge message, including necessary information/configuration for the UE to perform a conventional HO procedure to synchronize with a target cell of the target gNB. Upon receiving the HO request acknowledge message, the source gNB transmits an HO command (or an RRC Reconfiguration message with synchronization to the target cell), including at least the target cell configuration, to instruct the UE to perform a conventional HO procedure to the target cell. Therefore, the conventional HO procedure is triggered by Layer 3 (L3) measurement and is done by an RRC signaling to instruct the UE to HO from a source cell to a target cell. However, the serving source gNB may not always receive measurement reports from the UE or may not successfully transmit a handover (HO) command to the UE due to faster signal degradation or higher UE speed. This translates to a higher rate of HO failures. Also, the conventional HO procedure involves complete L2 (and L1) resets, leading to longer latency, larger overhead and longer interruption time than beam switch mobility.

To reduce the latency, overhead, and interruption time, in 3rd Generation Partnership Project (3GPP) Release 18, LTM was introduced to improve HO latency and interruption time compared to the conventional HO procedure. By definition, LTM is a cell switch procedure that the network triggers via Medium Access Control (MAC) Control Element (CE) based on L1 measurements. It should be noted that based on 5G protocol stack, L1 is physical layer and L3 is Radio Resource Control (RRC) layer. L2 include MAC, Radio Link Control (RLC), Packet Data Convergence Protocol (PDCP), Service Data Adaptation Protocol (SDAP) layers. As stated in TS 38.300 of Release 18, LTM is a procedure in which a gNB receives an L1 measurement report from a UE, and on that basis the gNB changes the UE serving cell via a cell switch command signaled by a MAC CE. The cell switch command indicates an LTM candidate configuration that the gNB previously prepared and provided to the UE through an RRC signaling. Then the UE switches to the target configuration according to the cell switch command.

FIG. 1 illustrates an example scenario 100 of signaling procedure for LTM as captured in TS 38.300 of Release 18. The scenario 100 involves a UE and a next-generation NB (gNB) (e.g., a base station (BS) or a transmission and reception point (TRP)) which may be part of a wireless network (e.g., a 5G NR network, a 5G network, or a 6G network). As shown in FIG. 1, the signaling procedure for LTM is performed when the UE is in the RRC_CONNECTED state.

In step 101, the UE transmits a MeasurementReport message to the gNB. Upon receiving the MeasurementReport message, the gNB decides to configure LTM and initiates LTM candidate preparation.

In step 102, the gNB transmits an RRCReconfiguration message to the UE, which includes the configuration of one or multiple LTM candidate cells.

In step 103, the UE stores the configuration of LTM candidate cell(s) and transmits an RRCReconfigurationComplete message to the gNB.

In step 104a, the UE may perform downlink (DL) synchronization with candidate cell(s) before receiving the LTM cell switch command.

In step 104b, the UE may perform uplink (UL) synchronization and timing advance (TA) acquisition with candidate cell(s) before receiving the LTM cell switch command. In case that UE-based TA measurement is configured (as introduced in TS 38.331 of Release 18), the UE acquires the TA value(s) of the candidate cell(s) using the UE-based TA measurement. Alternatively, the UE performs early TA acquisition with the candidate cell(s) as requested by the gNB before receiving the LTM cell switch command. This is done via Contention-Free Random Access (CFRA) triggered by a Physical Downlink Control Channel (PDCCH) order from a source cell, following which the UE sends preamble towards the indicated candidate cell. In order to minimize the data interruption of the source cell due to CFRA towards the candidate cell(s), the UE does not receive a random access response from the gNB for the purpose of TA value acquisition and the TA value of the candidate cell is indicated in the LTM cell switch command. The UE does not maintain the TA timer for the candidate cell and relies on network implementation to guarantee the TA validity.

In step 105, the UE performs L1 measurements on the configured LTM candidate cell(s), and transmits an L1 measurement reports to the gNB, wherein the L1 measurements should be performed as long as RRC reconfiguration (in step 102) is applicable. Upon receiving the L1 measurement reports, the gNB may decide to execute the LTM cell switch to a target cell.

In step 106, the gNB decides to execute cell switch to the target cell and transmits a MAC control element (MAC-CE) triggering cell switch by including the candidate configuration index of the target cell. In response to the triggering of LTM cell switch, the UE switches to the target cell and applies the configuration indicated by candidate configuration index.

In step 107, the UE performs a random access procedure towards the target cell, if the UE does not have valid TA of the target cell as specified in TS 38.321 of Release 18.

In step 108, the UE completes the LTM cell switch procedure by sending RRCReconfigurationComplete message to the target cell. When the UE has performed a RA procedure in step 107 and the random access procedure is successfully completed, the UE considers that LTM cell switch procedure is successfully completed. For RACH-less LTM, the UE considers that LTM cell switch procedure is successfully completed when the UE determines that the gNB has successfully received its first UL data. It should be noted that RACH-less LTM is an LTM cell switch procedure where the UE skips the random access procedure.

In the design of Release 18, LTM still has room for further improvements. In RP-234036, a new work item was approved for further New Radio (NR) mobility enhancement. One of the objectives of this new work item is to support conditional LTM to achieve higher robustness by following the concept of conditional handover (CHO). As introduced in TS 38.300 v16.15.0, a CHO is defined as a handover that is executed by the UE when one or more handover execution conditions are met, without necessitating a signaling exchange with source cell beforehand. By introducing conditional LTM mechanism, UE mobility can benefit from both the high robustness and short interruption.

However, many details of the whole conditional LTM design are not yet defined, e.g., related configuration design for supporting conditional LTM design, means to perform early UL synchronization (or acquire valid timing advance/TA value) to a target candidate cell for conditional LTM design considering that LTM Cell Switch Command MAC CE (as specified in TS 38.321 of Release 18) may not be received by a UE which intend to perform a conditional HO procedure, corresponding UE behavior to perform a conditional LTM procedure, and etc.

As such, how to design a conditional LTM procedure has become an important issue. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and an apparatus for a conditional Layer 1/Layer 2 (L1/L2) triggered mobility (LTM) procedure is provided in the present disclosure. The main purpose of the disclosure is to support the conditional LTM procedure, including the UE capability reporting for supporting the conditional LTM procedure, information required for the conditional LTM configuration, steps of different types of the conditional LTM procedures, a new MAC CE providing a TA value for the early UL synchronization to a target candidate cell, an overall TA management for performing the conditional LTM procedure, and cross-layer interactions.

In an exemplary embodiment, a method for a conditional Layer 1/Layer 2 (L1/L2) triggered mobility (LTM) procedure is provided. The method is implemented by a user equipment (UE) and comprises receiving a conditional LTM command from a source base station (BS), wherein the conditional LTM command includes a first target cell configuration of a first target cell and an execution condition. The method comprises receiving a first Medium Access Control (MAC) Control Element (CE) associated with the first target cell from the source BS, wherein the first MAC CE includes Timing Advance (TA)-related information. The method comprises switching to the first target cell by applying the first target cell configuration and the received TA-related information when the execution condition is fulfilled.

In an exemplary embodiment, an apparatus for a conditional Layer 1/Layer 2 (L1/L2) triggered mobility (LTM) procedure is provided. The apparatus comprises a transceiver and a processor. The transceiver which, during operation, wirelessly communicates with at least one network node. The processor communicatively coupled to the transceiver such that, during operation, the processor performs operations comprising generating a not-allowed cell list of new radio (NR) standalone (SA) cells. The processor performs operations comprising receiving a conditional LTM command from a source base station (BS), wherein the conditional LTM command includes a first target cell configuration of a first target cell and an execution condition. The processor performs operations comprising receiving a first Medium Access Control (MAC) Control Element (CE) associated with the first target cell from the source BS, wherein the first MAC CE includes Timing Advance (TA)-related information. The processor performs switching to the first target cell by applying the first target cell configuration and the received TA-related information when the execution condition is fulfilled.

In an exemplary embodiment, a method for a conditional Layer 1/Layer 2 (L1/L2) triggered mobility (LTM) procedure is provided. The method is implemented by a source base station (BS) and comprises transmitting a conditional LTM command to a user equipment (UE), wherein the conditional LTM command includes a first target cell configuration of a first target cell and an execution condition; and transmitting a first Medium Access Control (MAC) Control Element (CE) associated with the first target cell to the UE, wherein the first MAC CE includes Timing Advance (TA) related information.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates an example scenario of signaling procedure for LTM.

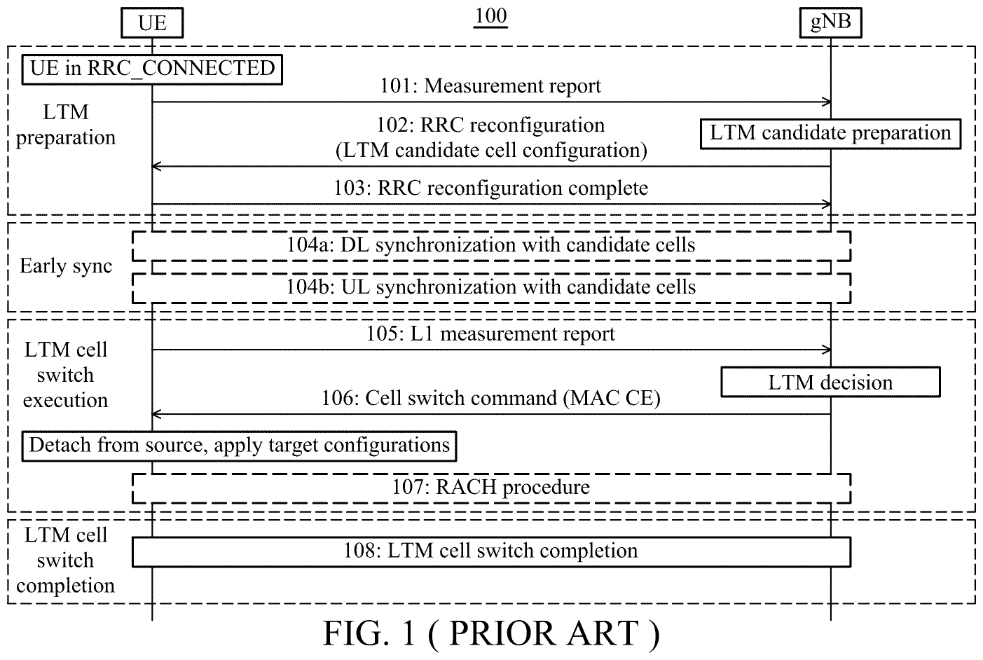

FIG. 2 shows a UE capability reporting procedure according to an implementation of the present disclosure.

FIG. 3 shows a conditional LTM procedure according to an implementation of the present disclosure.

FIG. 4 shows a conditional LTM procedure according to an implementation of the present disclosure.

FIG. 5 shows a conditional LTM procedure according to an implementation of the present disclosure.

FIG. 6 shows a conditional LTM procedure according to an implementation of the present disclosure.

FIG. 7 shows an early UL TA acquisition procedure triggered by a PDCCH order according to an implementation of the present disclosure.

FIG. 8 shows an LTM TA command MAC according to an implementation of the present disclosure.

FIG. 9 shows a TA management flowchart for the conditional LTM procedure according to an implementation of the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION OF THE INVENTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G, and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaptation may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

### UE Capability

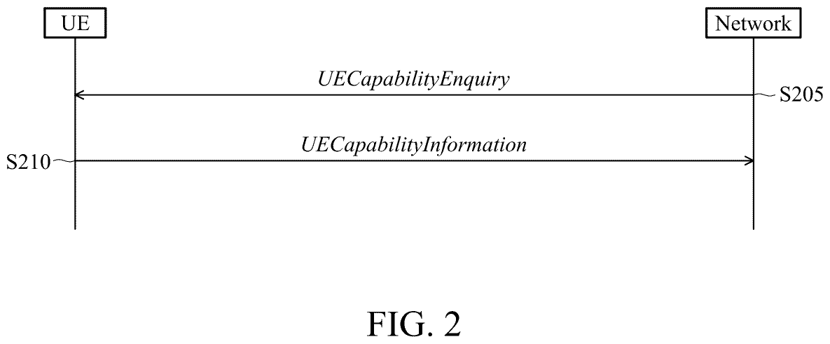

FIG. 2 shows a UE capability reporting procedure according to an implementation of the present disclosure. In step S205, the network (NW) may initiate this procedure with a UE in RRC_CONNECTED state when the NW needs UE capability information. That is, the NW may transmit a UE capability enquiry message (i.e., UECapabilityEnquiry message) to the UE and then the UE may report the requested UE capability message in a UE capability information message (i.e., UECapabilityInformation message) in step S210.

In one implementation, the UE may report its capability of supporting a conditional LTM procedure to the NW. When the UE supports the conditional LTM procedure, it means that NW may provide an LTM candidate configuration and associated execution condition(s) to the UE. When the associated execution condition(s) is fulfilled, the UE may execute or apply the LTM candidate configuration by itself, without receiving any NW signaling to instruct the UE to apply the LTM candidate configuration to switch or hand over to the new serving cell (or the candidate target cell). In another implementation, when the UE reports its capability of supporting performing a conditional LTM procedure to the NW, the UE may also support performing subsequent LTM and/or subsequent conditional LTM. It should be noted that the subsequent LTM may be done by repeating the early synchronization, the LTM cell switch execution, and/or the LTM cell switch completion steps without releasing other LTM candidate configuration(s) after each LTM cell switch completion. It should be noted that the subsequent conditional LTM may be done by repeating the early synchronization, the execution condition(s) evaluation, the LTM cell switch execution, and/or the LTM cell switch completion steps without releasing other conditional LTM candidate configuration(s) after each (conditional) LTM cell switch completion. In one implementation, the UE may report one capability of supporting subsequent LTM and another capability of supporting subsequent conditional LTM.

In one implementation, the UE may report separate capabilities of supporting a conditional LTM procedure to the NW, one for supporting a conditional LTM procedure and the other for supporting subsequent LTM and/or subsequent conditional LTM. In one implementation, the UE may report one capability of supporting LTM procedure, one capability of supporting a conditional LTM procedure, one capability of supporting subsequent LTM, and one capability of supporting subsequent conditional LTM.

In one implementation, the UE may report separate capabilities of supporting a conditional LTM procedure to the NW, one for supporting intra-CU conditional LTM procedure and the other for supporting inter-CU conditional LTM. For example, when the UE reports the supporting of intra-CU conditional LTM procedure, the NW may configure intra-CU conditional LTM configuration(s) to the UE. For example, when the UE reports the supporting of inter-CU conditional LTM procedure, the NW may configure inter-CU conditional LTM configuration(s) to the UE.

In one implementation, the UE may report its capability of supporting of event-triggered L1 measurement for the conventional LTM procedure. For example, when the UE reports the supporting of event-triggered L1 measurement, the NW may configure the UE to perform a synchronization signal block (SSB) based or a channel state information referenced signal (CSI-RS) based L1 measurements by providing associated information of SSB or CSI-RS and/or associated triggered conditions (e.g., based on a kind of measurement event) for measurement reporting.

In one implementation, the UE may report its capability of supporting execution condition(s) of a conditional LTM configuration based on L1 measurements. In one implementation, the UE may report its capability of supporting execution condition(s) of a conditional LTM configuration based on L3 measurements. In another implementation, when the UE reports its capability of supporting a conditional LTM procedure to the NW, the UE may also support execution condition(s) of a conditional LTM configuration based on L1 and/or L3 measurements. It should be noted that whether an execution condition is based on L1 measurements or L3 measurements may depend on the NW configuration (e.g., based on the report configuration or measurement configuration associated with received conditional LTM candidate configuration.) That is, the NW may configure either an L1 execution condition or an L3 execution condition associated with a candidate target cell in a conditional LTM command.

In some implementations, the capabilities may be separated for Time Division Duplex (TDD) and Frequency Division Duplex (FDD). For example, the UE may report one capability of supporting performing a conditional LTM procedure in the TDD and report another capability of supporting performing a conditional LTM procedure in the FDD. In another example, the UE may report one capability of supporting subsequent LTM and/or subsequent conditional LTM in the TDD and report another capability of supporting subsequent LTM and/or subsequent conditional LTM in the FDD.

In some embodiments, the capabilities may be separated for Frequency Range 1 (FR1) and Frequency Range 2 (FR2). For example, a UE may report one capability of supporting performing a conditional LTM procedure in FR1 and report another capability of supporting a conditional LTM procedure in FR2. In another example, the UE may report one capability of supporting subsequent LTM and/or subsequent conditional LTM in the FR1 and report another capability of supporting subsequent LTM and/or subsequent conditional LTM in the FR2.

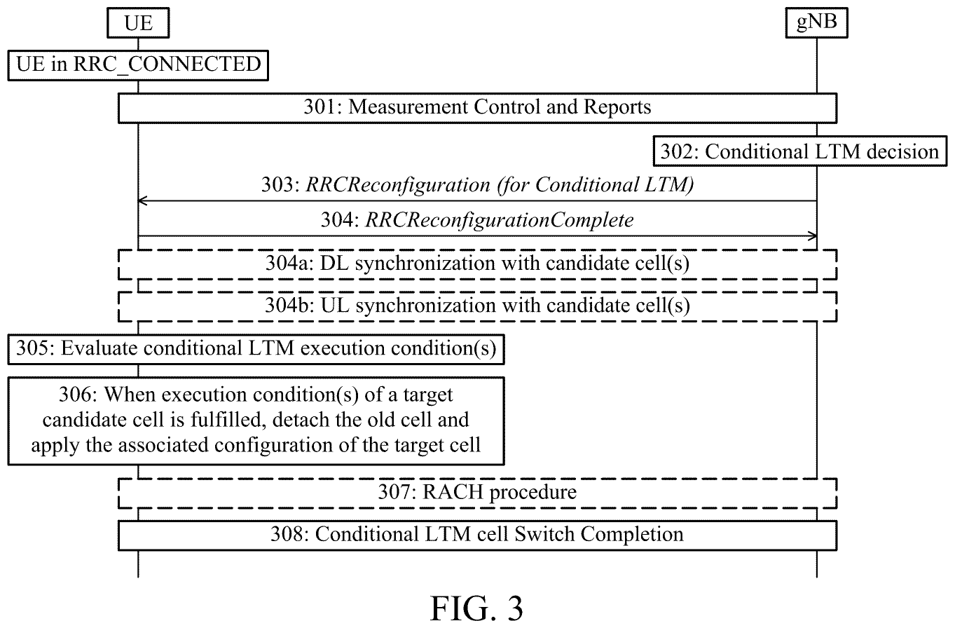

FIG. 3 shows a conditional LTM procedure according to an implementation of the present disclosure. It should be noted that one or more steps in FIG. 3 may or may not be performed. For example, the RACH procedure in Step 307 may not be performed when the UL synchronization in Step 304b was completed. Also, the order of the steps may not be mandatory. For example, the UE may start evaluating (configured) conditional LTM condition(s) before transmitting the RRCReconfigurationComplete message in Step 304.

In step 301, for the UE in the RRC_CONNECTED state, a serving gNB of the UE may configure UE measurement procedures, e.g., by providing L1 measurement configuration(s) or L3 measurement configuration(s), and the UE may report measurement results based on the L1 measurement configuration(s) or the L3 measurement configuration(s). The L1 measurement configuration or the L3 measurement configuration may be provided for Channel State Information Reference Signal (CRI-RS) based measurements or Synchronization Signal Block (SSB) based measurements for a specific target candidate cell. Based on the received measurement configuration(s), the UE may periodically report the measurement results to the serving gNB or the measurement results may be reported by event-triggered.

In step 302, the serving gNB may decide to use a conditional LTM, e.g., based on the received measurement results from the UE, a UE speed, or a current operating frequency. For intra-central unit (CU) conditional LTM, the serving gNB (or the CU of the current serving cell) may prepare configuration(s) of conditional LTM candidate target cell by itself and may transmit the related information to a distributed unit (DU) of the current serving cell (or source cell) and/or DU of the candidate target cell. For inter-CU conditional LTM (or inter-gNB conditional LTM), the serving gNB may send conditional LTM request for one or more candidate target cell(s) belonging to one or more candidate gNB(s). A conditional LTM request message may be sent to each candidate target cell (or its associated gNB). In one implementation, there may be an indication (or related information) in a request message to indicate that the request message is used for conditional LTM or traditional LTM. It should be noted that the traditional LTM is a cell switch procedure that the network triggers via Medium Access Control (MAC) Control Element (CE) based on L1 measurements as introduced in 3GPP Release 18. Therefore, there is no execution condition for the traditional LTM. In one example, when the indication (or related information) indicates that the request message is used for the conditional LTM, the candidate gNB may provide the execution condition(s) and/or the candidate target cell configuration for the conditional LTM (or LTM candidate configuration) in the request acknowledge message. When the indication (or related information) indicates that the request message is used for the traditional LTM, the candidate gNB may provide the candidate target cell configuration in the request acknowledge message without any execution condition(s). In another example, when a request is used for the conditional LTM, the candidate gNB may provide CFRA resource(s)/configuration(s) and/or contention-based random access (CBRA) resource(s)/configuration(s) for the conditional LTM in the request acknowledge message for the UE to perform the RA procedure to synchronize with a candidate target cell. In one implementation, there may be an indication (or related information) in the request message to indicate whether the early UL synchronization is required for the conditional LTM. In one example, when the indication (or related information) indicates that whether the early UL synchronization is required for the conditional LTM, the candidate gNB may provide CFRA resource(s)/configuration(s) and/or contention-based random access (CBRA) resource(s)/configuration(s) for the conditional LTM in the request acknowledge message for the UE to perform the RA procedure to synchronize with a candidate target cell before applying the candidate target cell configuration. In one implementation, there may be a life timer T1 associated with the CFRA resource(s). When the life timer T1 expires, the CFRA resource(s) may be considered as invalid such that the UE may not be allowed to use the CFRA resource(s) to perform the RA procedure. On the other hand, the candidate gNB may also release the CFRA resource(s) when the life timer T1 expires such that the RA resources may be assigned to other UEs. In another example, when the indication (or related information) indicates that early UL synchronization is required for the conditional LTM, the candidate gNB may provide a timing advance (TA) value associated with the target candidate cell in the request acknowledge message. For example, the TA value may be 0 or a configured one. In another implementation, there may be a life timer T2 associated with the TA value. When the life timer T2 expires, the TA value may be considered as invalid such that the UE may not allowed to use the TA value to perform a RACH-less conditional LTM cell switch. It should be noted that the value of the lifer timer T2 may be configured by the target gNB which provides the CFRA resource(s) or CFRA configuration(s).

It should be noted that “candidate target cell configuration for the conditional LTM”, “candidate target cell configuration”, and “LTM candidate configuration” are exchangeable in this disclosure.

In step 303, the serving gNB may transmit an RRCReconfiguration message to the UE, including at least the LTM candidate configuration(s) and conditional LTM execution condition(s). It should be noted that the conditional LTM candidate configuration includes as least one LTM candidate configuration (of a target candidate cell) and at least one associated conditional LTM execution condition. The conditional LTM candidate configuration may also be identified by a (conditional) LTM ID. The (conditional) LTM ID may be assigned by the (source) serving gNB. The serving gNB may release the conditional LTM candidate configuration by indicating its associated (conditional) LTM ID in a NW signaling. Also, “conditional LTM execution condition(s)” and “execution condition(s)” may be exchangeable in this disclosure. In case of intra-CU conditional LTM, the execution condition(s) may be generated by the original serving CU (or the serving gNB). In case of inter-CU conditional LTM, the execution condition(s) of a candidate target cell may be generated by a candidate gNB of the candidate target cell. The execution condition may be associated with a measurement ID (e.g., measID) or an associated measurement report configuration. The associated measurement report configuration may be provided for SSB based L1 measurement(s), CRI-RS based L1 measurement(s), SSB based L3 measurement(s), or CRI-RS based L3 measurement(s). The associated measurement report configuration may be indicated for the conditional LTM. In case that the associated measurement report configuration is indicated for the conditional LTM (e.g., a specific information element is present in the measurement report configuration), the UE may evaluate the configured measurement event(s) without reporting any measurement results to the gNB. In one implementation, whether the measurement results associated with a satisfied execution condition are sent to the gNB may be configured by the gNB.

In one implementation, the RRCReconfiguration message or the conditional LTM candidate configuration may include CFRA resource(s)/configuration(s) and/or contention-based random access (CBRA) resource(s)/configuration(s) for the UE to perform the RA procedure to synchronize with the corresponding candidate target cell. To avoid RA resource(s) waste, the RRCReconfiguration message or the conditional LTM candidate configuration may include CFRA resources/configuration and an associated life timer T1. The value of the life timer T1 may be provided by a gNB associated with the target candidate cell (e.g., in a request acknowledgement message). In case that life timer T1 expires, the UE may release/suspend the CFRA resource(s)/configuration(s). The life timer T1 may start upon the UE receives the RRCReconfiguration message or the conditional LTM candidate configuration.

In one implementation, the RRCReconfiguration message or the conditional LTM candidate configuration may include a TA value associated with a candidate target cell. The UE may apply the TA value to synchronize with the candidate target cell (in uplink direction). For the TA management, the RRCReconfiguration message or the conditional LTM candidate configuration may include the TA value associated with a candidate target cell and an associated life timer T2. The value of the life timer T2 may be provided by a gNB associated with the target candidate cell (e.g., in a request acknowledgement message). In case that the life timer T2 expires, the UE may consider the TA value associated with the candidate target cell is invalid. That is, the UE may need to perform a RACH-based conditional LTM cell switch when the corresponding execution condition(s) of the conditional LTM candidate configuration is fulfilled. In case that the life timer T2 is running, the UE may consider that TA value associated with the candidate target cell is valid and the UE may perform the RACH-less conditional LTM cell switch when the corresponding execution condition(s) of the conditional LTM candidate configuration is fulfilled. The life timer T2 starts upon the UE receives the RRCReconfiguration message or the conditional LTM candidate configuration.

In one implementation, the RRCReconfiguration message or the conditional LTM candidate configuration may include an (explicit) indication (or related information) to indicate whether the RA procedure for UL synchronization is required. For example, when the indication (or related information) is present or set to a specific value, the UE may perform the RA procedure to synchronize with a target candidate cell when applying the LTM candidate configuration of the target candidate cell. For example, when the indication (or related information) is absent or is set to a specific value, the UE may not perform a RA procedure to synchronize with a target candidate cell when applying the LTM candidate configuration of the target candidate cell. Instead, the UE may utilize the CFRA resource(s)/configuration(s) and/or contention-based random access (CBRA) resource(s)/configuration(s) in the RRCReconfiguration message or the conditional LTM candidate configuration to perform the RA procedure to synchronize with the target cell.

In one implementation, the RRCReconfiguration message or the conditional LTM candidate configuration may include an (explicit) indication (or related information) to indicate whether the RA procedure for the early UL synchronization is required. That is, the gNB may request the UE to perform the early TA acquisition of a candidate cell before a cell switch. For example, when the indication (or related information) is present or set to a specific value, the UE may perform an early UL synchronization procedure to a target candidate cell based on CFRA resource(s)/configuration(s), contention-based random access (CBRA) resource(s)/configuration(s), and/or PDCCH order provided in the RRCReconfiguration message, the conditional LTM candidate configuration, a downlink control information (DCI) or a MAC CE.

In one implementation, the RRCReconfiguration message or the conditional LTM candidate configuration may include an (explicit) indication (or related information) to indicate whether the early DL synchronization is required. In one implementation, the RRCReconfiguration message or the conditional LTM candidate configuration may include Transmission Configuration Indication (TCI) states related information of a target candidate cell of a conditional LTM candidate configuration. In one implementation, the network (or the gNB) may activate TCI state(s) of a target candidate cell before the target candidate cell becomes a new serving cell. In one implementation, the RRCReconfiguration message, the conditional LTM candidate configuration, a DCI, or a MAC CE may include TCI states related information of a target candidate cell of a conditional LTM candidate configuration and the initial states of all TCI states are deactivated. In one implementation, the RRCReconfiguration message, the conditional LTM candidate configuration, a DCI, or a MAC CE may include TCI states related information of a target candidate cell of a conditional LTM candidate configuration, and the initial states of all TCI states are activated. In one implementation, the RRCReconfiguration message, the conditional LTM candidate configuration, a DCI, or a MAC CE may include TCI states related information of a target candidate cell of a conditional LTM candidate configuration, and the TCI states related information indicates the state of one TCI state is activated or deactivated. For example, the network (or the gNB) may configure TCI state #1 and TCI sate #2 for a target candidate cell, and TCI state #1 is configured as “activated” and TCI state #2 is configured as “deactivated.”

In step 304a, the UE may perform a (early) DL synchronization procedure with a target candidate cell before applying an LTM candidate configuration of the target candidate cell. It should be noted that the LTM candidate configuration may be applied since the conditional LTM execution condition(s) associated with the LTM candidate configuration is fulfilled. Whether the UE may perform the (early) DL synchronization procedure with a target candidate cell before applying the LTM candidate configuration of the target candidate cell may depend on network configuration(s) or control signaling. In one implementation, the RRCReconfiguration message or the conditional LTM candidate configuration may include an indication (or related information) to indicate whether a (early) DL synchronization procedure is required. In case that the (early) DL synchronization procedure is required/configured for a target candidate cell, the UE may perform the (early) DL synchronization procedure for the target candidate cell before the conditional LTM configuration associated with the target candidate cell is applied. To perform the (early) DL synchronization procedure, the serving gNB may active TCI state(s) of a target candidate cell in advance (e.g., via a DCI or a MAC CE) before the conditional LTM configuration associated with the target candidate cell is applied.

In step 304b, the UE may perform a (early) UL synchronization procedure with the target candidate cell before applying the LTM candidate configuration of the target candidate cell. It should be noted that the LTM candidate configuration may be applied since the conditional LTM execution condition(s) associated with the LTM candidate configuration is fulfilled. Whether the UE may perform the (early) UL synchronization procedure with a target candidate cell before applying the LTM candidate configuration of the target candidate cell may depend on network configuration(s) or the NW control signaling. In one implementation, the RRCReconfiguration message or the conditional LTM candidate configuration may include an indication (or related information) to indicate whether the (early) UL synchronization procedure is required. In case that the (early) UL synchronization procedure is required/configured for a target candidate cell, the UE may perform the (early) UL synchronization procedure for a target candidate cell before the conditional LTM configuration associated with the target candidate cell is applied. To perform the (early) UL synchronization procedure, the serving gNB may provide uplink resources (e.g., RA resources or PDCCH order) for the UE to at least transmit a preamble in advance before the conditional LTM configuration associated with the target candidate cell is applied. In another implementation, whether to perform or how to perform the (early) UL synchronization procedure (e.g., a NW triggered procedure or a UE calculated procedure) may depend on the NW configuration or the NW signaling. It should be noted that the NW triggered procedure may be a (early) UL synchronization procedure, which the NW may provide a TA value of a target candidate cell to the UE (e.g., provided a TA value via an RRC signaling or a MAC CE). Moreover, it should be noted that the UE calculated procedure may be a (early) UL synchronization procedure, in which the UE measures/calculates a TA value of a target candidate cell by itself. For example, the UE may measure/calculate a TA value of a target candidate cell by deriving TA based on Rx timing difference between the current serving cell and the candidate cell as well as the TA value for the current serving cell. In one implementation, when the (early) UL synchronization procedure for a target candidate cell is successfully completed (e.g., a valid TA value is obtained from an RRC signaling or a MAC CE), a timer T3 starts. For example, the timer T3 starts when the UE receives a MAC CE including a TA value associated with a target candidate cell. When the timer T3 is running, the TA value is considered as valid and may be used for switching to the target candidate cell. When the timer T3 expires, the TA value is considered as invalid and may not be used for switching to the target candidate cell. For example, the UE may consider that a TA value associated with a target candidate cell is invalid when the timer T3 expires. In this case, another (early) UL synchronization procedure may be performed or triggered. In one implementation, when the UE is configured to measure/calculate a TA value of a target candidate cell by itself, the UE may need to guarantee that the measured/calculated TA value is valid. The value of the timer T3 may be configurable (via an RRC signaling, a MAC CE, or DCI), or pre-defined.

In one implementation, when the (early) UL synchronization procedure is completed (i.e., a valid TA value of a target candidate cell is obtained/stored) before switching to the target candidate cell and execution condition(s) of the conditional LTM configuration of the target candidate cell is fulfilled, the UE may apply the TA and apply the LTM configuration of the target candidate cell without performing the RA procedure. When the (early) UL synchronization procedure is not completed (or an obtained/stored TA value becomes invalid) before switching to the target candidate cell and execution condition(s) of the conditional LTM configuration of the target candidate cell is fulfilled, the UE may apply the LTM candidate configuration of the target candidate cell and perform the RA procedure for TA acquisition.

In step 305, the UE may start evaluating conditional LTM execution condition(s) upon receiving the conditional LTM candidate configuration(s). The UE may stop evaluating the conditional LTM execution condition(s) once a handover is executed (e.g., a traditional LTM is executed, a conditional LTM is executed, a traditional HO is executed, or a CHO is executed).

In step 306, the UE may maintain connection with the current serving gNB after receiving the conditional LTM candidate configuration(s) and may start evaluating the conditional LTM execution condition(s) for target candidate cell(s) associated with the received conditional LTM candidate configuration(s). When at least one target candidate cell satisfies the corresponding conditional LTM execution condition(s), the UE may detach from the current serving gNB, trigger the LTM cell switch procedure, and/or apply the stored LTM candidate configuration for that selected target candidate cell. In one implementation, when more than one target candidate cell satisfies the corresponding conditional LTM execution condition(s) (or triggers the LTM cell switch procedure(s)), the UE may randomly select a target candidate cell to trigger the LTM cell switch procedure by applying the stored LTM candidate configuration of the selected target candidate cell. In another implementation, each target candidate cell may be configured with a priority value. When more than one target candidate cell satisfies the corresponding conditional LTM execution condition(s), the UE may select a target candidate cell with a highest priority value to trigger the LTM cell switch procedure by applying the stored LTM candidate configuration for the selected target candidate cell. When there is more than one target candidate cell with the same highest priority value, the UE may randomly select one cell among these target candidate cells.

In step 307, the UE may perform the RA procedure towards the target cell, when the UE does not have valid TA of the target candidate cell or the early UL synchronization procedure is not successfully completed.

In step 308, the UE may complete the conditional LTM procedure by sending the RRCReconfigurationComplete message to the selected target candidate cell (or its associated gNB). After the UE has performed the RA procedure in step 307, the UE may consider that the conditional LTM procedure is successfully completed when the random access procedure is successfully completed. The RRCReconfigurationComplete message may include an information element field to indicate the LTM ID of the selected conditional LTM candidate configuration the UE applies upon the execution of conditional LTM. When the UE has a valid TA of the selected target candidate cell and no RA procedure is required to be performed, the UE may consider that the conditional LTM procedure is successfully completed when the UE determines that the network (or the new serving gNB) has successfully received the first UL data of the UE.

In one implementation, when subsequent conditional LTM is configured, the UE starts evaluating execution conditions of conditional LTM candidate configuration(s) associated with the new serving cell, if any.

### Signaling Procedure for Conditional LTM with UE Notification and NW Response

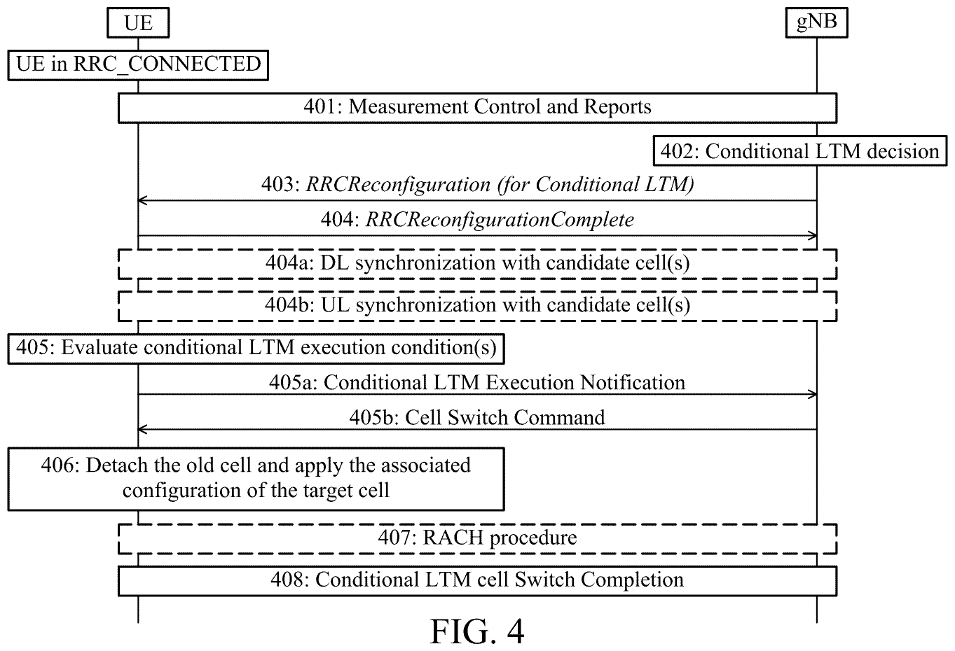

FIG. 4 shows a conditional LTM procedure according to an implementation of the present disclosure, wherein the UE transmits a conditional LTM execution notification, and the NW responds a cell switch command in response to the conditional LTM execution notification. It should be noted that one or more steps in FIG. 4 may or may not be performed. Also, the order of the steps may not be mandatory.

As shown in FIG. 4, steps 401, 402, 403, 404, 404a, 404b, 405, 407 and 408 may substantially correspond to steps 301, 302, 303, 304, 304a, 304b, 305, 307 and 308, respectively, in FIG. 3, so the details related to the steps will be omitted.

In step 405, the UE may maintain connection with the current serving gNB after receiving the conditional LTM candidate configuration(s) and may start evaluating conditional LTM execution condition(s) for target candidate cell(s) associated with the received conditional LTM candidate configuration(s).

In step 405a, the UE may send a conditional LTM execution notification message to the gNB when at least one target candidate cell satisfies the corresponding conditional LTM execution condition(s). The conditional LTM execution notification message may include the information related to the conditional LTM candidate configuration (e.g., its LTM ID) to be executed (e.g., its associate execution condition(s) is fulfilled), latest L1 or L3 measurement results, beam information (e.g., selected UL beam(s) or selected DL beam(s)), and/or applied TA value (e.g., the TA value calculated/measured by UE itself), but it should not be limited in the disclosure. It should be noted that the UE may still maintain connection with the current serving gNB after sending a conditional LTM execution notification message. Moreover, the UE may not detach from the current serving gNB and may not apply the stored LTM candidate configuration for that selected target candidate cell even though the corresponding execution condition(s) are fulfilled. In one implementation, when more than one target candidate cell satisfies the corresponding conditional LTM execution condition(s), the conditional LTM execution notification message may include the information related to more than one conditional LTM candidate configuration (e.g., its LTM ID) to be executed for the NW for reference.

In step 405b, in response to receiving the conditional LTM execution notification message from the UE, the gNB may reply with a cell switch command which may be RRC signaling, a MAC CE, or a DCI. The cell switch command may include a conditional LTM candidate configuration (e.g., its LTM ID) to be executed, response information (e.g., accept or reject), beam information (e.g., selected UL beam(s) or selected DL beam(s)), RA related information (e.g., dedicated RA resource(s)/preamble index), TCI state related information (e.g., activated TCI state(s) for the target candidate cell), and/or a configured TA value to apply, but it should not be limited in the disclosure.

In step 406, upon receiving the cell switch command, the UE may perform the related procedure accordingly. In one implementation, when the cell switch command indicates the conditional LTM candidate configuration (e.g., by indicating an LTM ID) to be executed, the UE may detach from the current serving gNB and apply the LTM candidate configuration indicated in the cell switch command. Moreover, the UE may stop evaluating the conditional LTM execution condition(s). In one implementation, when the cell switch command includes an accept response information, the UE may detach from the current serving gNB and apply the LTM candidate configuration indicated in the conditional LTM execution notification message. Moreover, the UE may stop evaluating the conditional LTM execution condition(s). In one implementation, when the cell switch command includes a reject response information, the UE may not detach from the current serving gNB and may not apply the LTM candidate configuration indicated in the conditional LTM execution notification message. In one implementation, when the cell switch command includes a reject response information, the UE may stop evaluating the conditional LTM execution condition(s). In one implementation, when the cell switch command includes a reject response information, the UE may keep evaluating the conditional LTM execution condition(s). Based on the evaluation results, the UE may send another conditional LTM execution notification message to the gNB. The content of this conditional LTM execution notification message may be the same or different from the content of the previous rejected conditional LTM execution notification message. In another implementation, when the cell switch command includes a reject response information, a prohibit timer T4 may start and when prohibit timer T4 is running, the UE may be prohibited to send another conditional LTM execution notification message. The value of the prohibit time T4 may be configurable (via a RRC signaling, a MAC CE, or DCI), or pre-defined.

In some implementations, whether the UE configured with the conditional LTM candidate configuration(s) may perform the conditional LTM procedure as introduced in FIG. 3 (i.e., without the UE notification and the NW response) or the conditional LTM procedure in FIG. 4 (i.e., with the UE notification and the NW response) may depend on the NW configuration and/or the UE capabilities. For example, the NW may configure the UE to perform the conditional LTM procedure in FIG. 4 (i.e., with the UE notification and the NW response) because the UE reports the supporting of transmitting the conditional LTM execution notification message.

### Signaling Procedure for Conditional LTM with UE Notification and NW Response

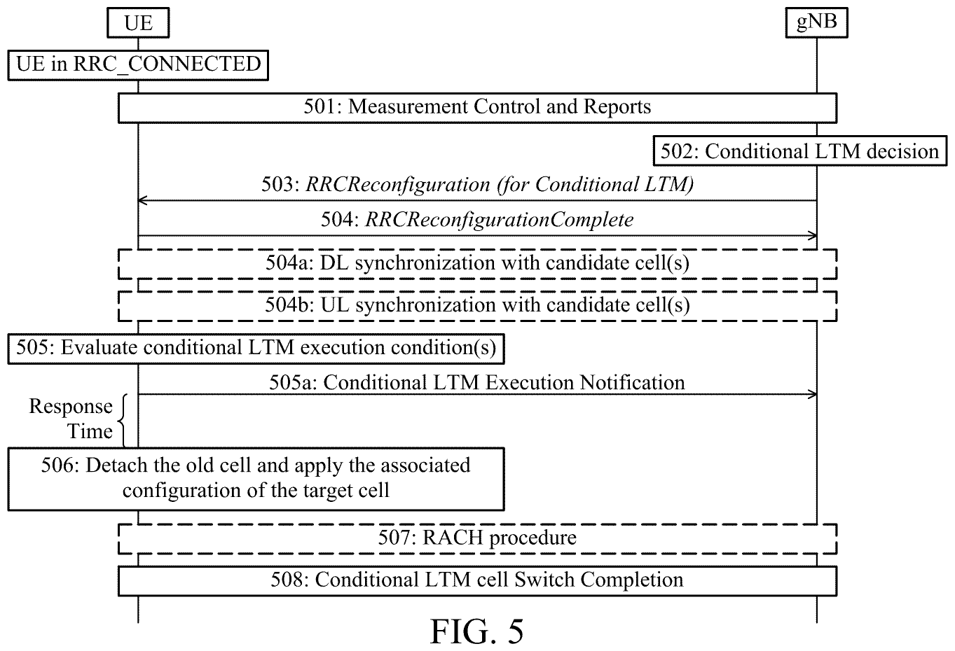

FIG. 5 shows a conditional LTM procedure according to an implementation of the present disclosure, wherein the UE transmits a conditional LTM execution notification but does not receive a cell switch command in respond to the notification within a response time period. It should be noted that one or more steps in FIG. 5 may or may not be performed. Also, the order of the steps may not be mandatory.

Compared to the conditional LTM procedure as introduced in FIG. 4, the difference in FIG. 5 is that the UE may not receive a cell switch command in respond to the conditional LTM execution notification message within a response time period. In one implementation, a response timer T5 may start upon transmitting the conditional LTM execution notification message. When the UE receives a cell switch command when the response timer T5 is running, the UE may perform the related procedure accordingly (e.g., as the actions and implementations introduced in step 406 of FIG. 4.). When the response timer T5 expires and the UE does not receive the cell switch command, the UE may autonomously detach from the current serving gNB and apply the stored LTM candidate configuration for that selected target candidate cell. In one implementation, the value of the response timer T5 may be configurable (via RRC signaling, a MAC CE, or DCI), or pre-defined.

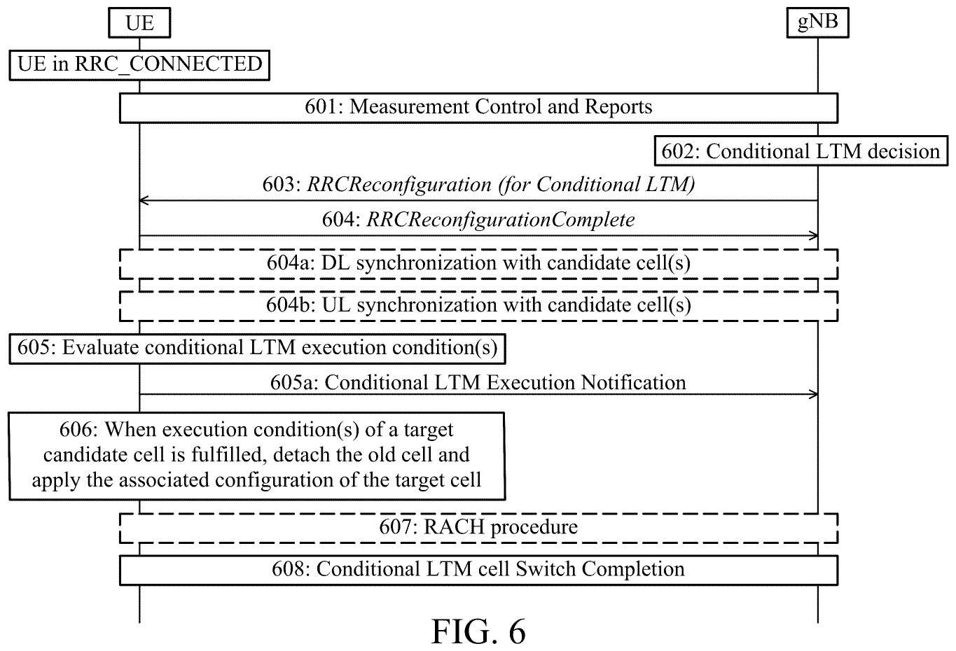

FIG. 6 shows a conditional LTM procedure according to an implementation of the present disclosure, wherein the UE transmits a conditional LTM execution notification but applies the target cell configuration without any NW response. It should be noted that one or more steps in FIG. 6 may or may not be performed. Also, the order of the steps may not be mandatory.

Compared to the conditional LTM procedure as introduced in FIG. 5, the difference in FIG. 6 is that after transmitting the conditional LTM execution notification message, the UE may autonomously detach from the current serving gNB and apply the stored LTM candidate configuration for that selected target candidate cell. It should be noted that the order of step 605a and step 606 may be changed. When the serving gNB receives the conditional LTM execution notification message, the serving gNB may know the conditional LTM candidate configuration is applied and may start forwarding data to a DU or a gNB of the target candidate cell to at least shorten the data transmission latency.

### UL Synchronization for Conditional LTM

For traditional LTM or conditional LTM procedure, early synchronization phase, e.g., step 304a and step 304b in FIG. 3, step 404a and step 404b in FIG. 4, step 504a and step 504b in FIG. 5, and step 604a and step 604b in FIG. 6 may be performed to shorten the latency and interruption time caused by an HO (or LTM cell switch procedure).

In one implementation, the NW (or a serving gNB, or a serving DU) may configure the UE to initiate the (early) UL TA acquisition procedure to one or more target candidate cells. When a target candidate cell has the same TA value as the current serving cell, the (early) UL TA acquisition may not be required. Whether a target candidate cell has the same TA value as the current serving cell may be informed by the NW (or the serving gNB, or the serving DU) via RRC signaling, a MAC CE, or a DCI. The NW (or the serving gNB, or the serving DU) may request the UE to perform the early UL TA acquisition of a target candidate cell before a cell switch to the target candidate cell.

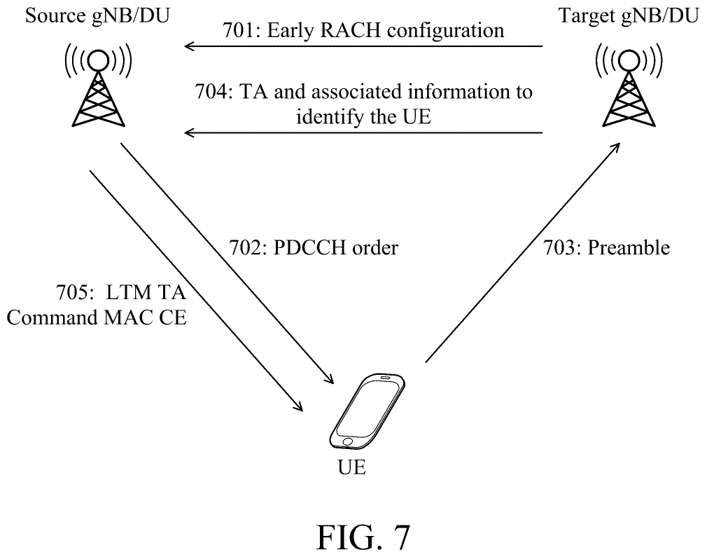

In one implementation, the NW (or a serving gNB, or a serving DU) may transmit a DCI (or PDCCH order) to trigger the UE to perform the early UL TA acquisition by transmitting a preamble without receiving any RA response (RAR). FIG. 7 shows an early UL TA acquisition procedure triggered by a PDCCH order according to an implementation of the present disclosure. To provide proper PDCCH order information for the UE to transmit a preamble, the target gNB/DU may provide the early RACH configuration of a target candidate cell to the source gNB/DU as shown in step 701 of FIG. 7. The early RACH configuration may include random access preamble indexes, SS/PBCH indexes, and/or a PRACH mask index, but it should not be limited in the disclosure. Upon receiving the PDCCH order as shown in step 702 of FIG. 7, the UE may transmit a preamble based on the received PDCCH order in step 703. The received PDCCH order may indicate whether the UE shall transmit a preamble on a normal UL (NUL) carrier or supplementary UL (SUL) carrier. In another implementation, the UE may use CBRA resource(s) or CFRA (resources) provided by the NW (e.g., in RRC signaling or a MAC CE) to transmit a preamble to a target candidate cell. Whether the UE may use the CBRA resource(s) or the CFRA (resources) on the NUL carrier or the SUL carrier may depend on the configured threshold. For example, when a signaling strength (e.g., current determined RSRP) is lower than or equal to the threshold, the UE may use the RA resources on the SUL carrier. For another example, when a signaling strength (e.g., current determined RSRP) is higher than or equal to the threshold, the UE may use the RA resources on the NUL carrier. When successfully receiving the preamble from the UE, the target gNB/DU may transmit TA value and/or associated information (e.g. preamble index, RA occasion information (i.e. RA-RNTI), or candidate cell identity) for the source gNB/DU to identify the UE as shown in step 704 of FIG. 7. When receiving these information for the target gNB/DU, the source gNB/DU may transmit an LTM TA Command MAC CE to the UE shown in step 705 of FIG. 7. In one implementation, after transmitting a preamble to the target gNB/DU, the UE may receive the LTM TA command MAC CE from the source gNB/DU to complete an early UL TA acquisition. In one implementation, the LTM TA command MAC CE is identified by a MAC subheader with a specific extended Logical Channel ID (eLCID). The LTM TA command MAC CE may include a field to indicate a target configuration ID (e.g., an LTM ID), a field to indicate target candidate cell (e.g., a cell ID), a TA command field to indicate TA-related information (e.g., a TA index value) to control the amount timing adjustment, a field to indicate a Timing Advance Group (TAG), a field to indicate and activate the TCI state of the target candidate cell, a field to indicate and activate a uplink TCI state of the target candidate cell, and/or a validity timer field for the TA command, but it should not be limited in the disclosure.

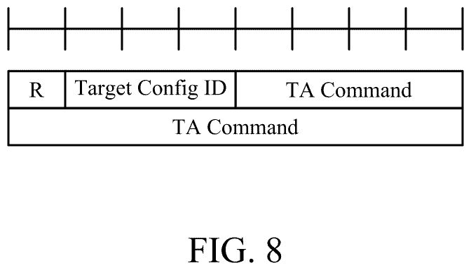

FIG. 8 shows an LTM TA command MAC according to an implementation of the present disclosure. As shown in FIG. 8, the LTM TA command MAC CE has a fixed size with following fields:

R: reserved bit, set to 0.

Target Configuration ID: this field indicates the index of candidate target configuration to apply for the conditional LTM. The length of the field is 3 bits. In another implementation, the length of the field is N bits, wherein N is predefined or configurable.

Timing Advance Command: this field indicates the TA value (or the associated TA index) for the target candidate cell (i.e. the special primary cell (SpCell) corresponding to the target configuration indicated by the Target Configuration ID field). In one implementation, when the value of the TA command is set to a specific value, it means that no valid TA value is available for the UE for the target candidate cell associated with the target configuration (identified by the target configuration ID).

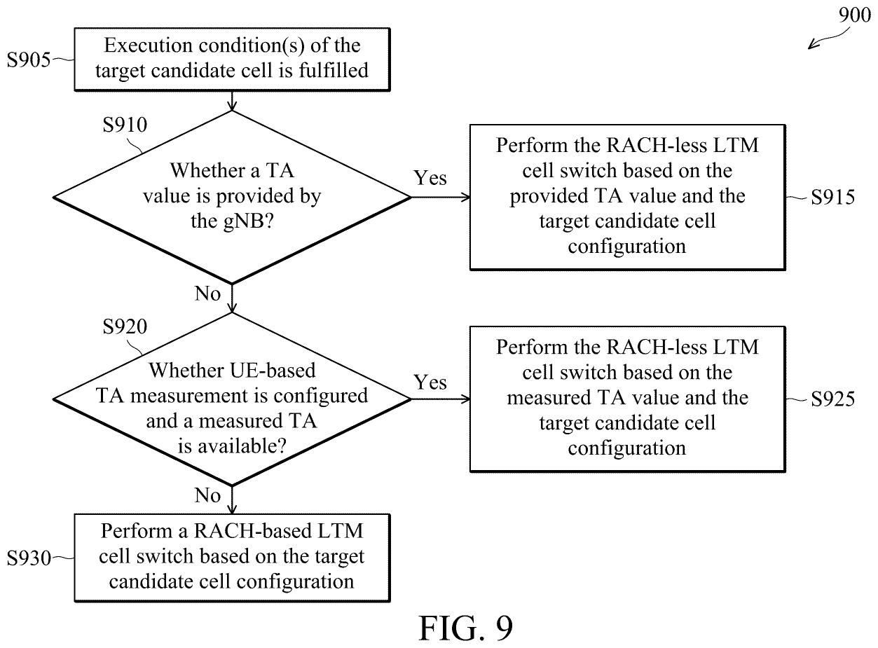

FIG. 9 shows a TA management flowchart 900 for the conditional LTM procedure according to an implementation of the present disclosure. When the early UL TA acquisition procedure is applied, the UE may receive a TA value of a target candidate cell from the gNB (e.g., via an LTM TA command MAC CE). In addition, the UE may receive a (valid) TA vale of a target candidate cell in RRC signaling or in an associated conditional LTM candidate configuration. As shown in FIG. 9, the UE may determine whether a (valid) TA value of a target candidate cell is received from the gNB before the conditional LTM candidate configuration is applied. For example, when the execution condition(s) of the conditional LTM candidate configuration is fulfilled, the UE may determine whether the RACH-less LTM cell switch is performed or the RACH-based LTM cell switch is performed based on the condition when a (valid) TA vale of the target candidate cell of the conditional LTM candidate configuration is received from the gNB. It should be noted that a RACH-less LTM cell switch (or a RACH-less LTM cell switch procedure) means that the UE may apply the received TA value directly without performing the RA procedure and may apply the target candidate cell configuration (in the associated conditional LTM candidate configuration). Instead, the RACH-based LTM cell switch (or the PACH-based LTM cell switch procedure) means that the UE may initiate the RA procedure to the target candidate cell and may apply the target candidate cell configuration (in the associated conditional LTM candidate configuration). When initiating the RA procedure, the UE may receive a TA command in a RAR of the RA procedure.

In one implementation, when the execution condition(s) of the conditional LTM candidate configuration is fulfilled in step S905 and the UE determines that a TA value of a target candidate cell is provided by the gNB (e.g., the UE determines that the TA value of the target candidate cell is stored and valid) (“Yes” in step S910), the UE may perform the RACH-less LTM cell switch based on the provided TA value and the target candidate cell configuration (in the associated conditional LTM candidate configuration) in step S915. In one implementation, when the received LTM TA command MAC CE including the TA Command field, the UE may apply the TA command (or the TA related information) for the primary timing advance group (pTAG) (or the associated cell group of the target candidate cell) and/or start (or restart) the timeAlignmentTimer (e.g., the timer T3) associated with the pTAG (or the associated cell group of the target candidate cell). When the timeAlignmentTimer (e.g., the timer T3) expires, the UE may consider that the TA command (or the TA related information) is invalid. It should be noted that the target candidate cell of the target configuration as indicated in the received LTM TA command MAC CE or the target candidate cell with the cell ID indicated in the received LTM TA command MAC CE may belong to the pTAG (or the associated cell group of the target candidate cell). In one implementation, when the TA value is provided in the RRC signaling or the conditional LTM candidate configuration, the UE may apply the TA value (or the TA related information) for the primary timing advance group (pTAG) (or the associated cell group of the target candidate cell) and/or start (or restart) the timeAlignmentTimer associated with the pTAG (or the associated cell group of the target candidate cell). When the timeAlignmentTimer (e.g., the timer T3) expires, the UE may consider that the TA command (or the TA related information) is invalid. When the timeAlignmentTimer (e.g., the timer T3) is running, the UE may consider that the TA command (or the TA related information) is still valid.

In another implementation, when the execution condition(s) of the conditional LTM candidate configuration is fulfilled in step S905 and the UE determines that the TA value of the target candidate cell is not provided by the gNB (e.g., the UE determines that the TA value of the target candidate cell is not stored or invalid) (“No” in step S910), the UE may further determine whether the UE-based TA measurement is configured and a measured TA is available (e.g., the UE calculated procedure is successfully completed or the valid measured TA is stored) in step S920. In one implementation, when the execution condition(s) of the conditional LTM candidate configuration is fulfilled in step S905, the UE determines that the UE-based TA measurement is configured and the measured TA is available (e.g., the UE calculated procedure is successfully completed or the valid measured TA is stored) (“Yes” in step S920), the UE may perform the RACH-less LTM cell switch based on the measured TA value and the target candidate cell configuration (in the associated conditional LTM candidate configuration) in step S925. In one implementation, when no LTM TA command MAC CE is received before the conditional LTM candidate configuration is applied and the UE has successfully measured the TA, the UE may apply the measured timing advance for the pTAG (or the associated cell group of the target candidate cell) and/or start (or restart) the timeAlignmentTimer (e.g., the timer T3) associated with the pTAG (or the associated cell group of the target candidate cell). When the time AlignmentTimer (e.g., the timer T3) expires, the UE may consider that the TA command (or the TA related information) is invalid. In one implementation, the gNB may configure/instruct whether the UE is allowed to apply its calculated/measured TA to synchronize with a target candidate cell. In case that the UE is not allowed to apply its calculated/measured TA to synchronize with a target candidate, the UE may skip the determination step of “whether the UE-based TA measurement is configured, and the measured TA is available” in the flowchart as shown in FIG. 9.

In another implementation, when the execution condition(s) of the conditional LTM candidate configuration is fulfilled in step S905, but the UE determines that neither a TA valued provided by the gNB is available/valid nor the UE-based TA measurement is not configured (or a measured TA is not available) (e.g., the UE calculated procedure is not successfully completed or the valid measured TA is not stored), the UE may perform a RACH-based LTM cell switch based on the target candidate cell configuration (in the associated conditional LTM candidate configuration) in step S930.

In some implementations, the conditional LTM configuration may be applied only when the associated execution condition(s) is fulfilled, and the TA (to the target cell) is available.

When the associated execution condition(s) of the conditional LTM configuration is fulfilled but no TA (to the target cell) is available, the UE may not apply the conditional LTM candidate configuration but report L1/L3 measurement results to the gNB.

In some implementations, whether the TA value (to the target cell) is required for applying the conditional LTM configuration is based on the NW configuration. For example, in the conditional LTM configuration, the TA required indication is included to indicate whether the TA (to the target cell) is required for applying the conditional LTM configuration. For example, when the TA required indication is absent (or set to a specific value, e.g., 0), the UE is allowed to apply the conditional LTM configuration without any current available TA value (to the target cell). In this case, the UE may apply the RA procedure to receive the TA value and complete the UL synchronization to the target cell.

### Cross-Layer Interaction

In one implementation, when the execution condition(s) of the conditional LTM candidate configuration is fulfilled (e.g., based on L1 measurements), a lower layer (e.g., PHY layer of the UE) may inform/notify an upper layer (e.g., MAC layer of the UE) that the execution condition(s) of the conditional LTM candidate configuration is fulfilled (e.g., by providing the associated target configuration ID or other related information). Upon receiving the notification/information from the lower layer, the upper layer may perform the LTM cell switch procedure. The upper layer (e.g., MAC layer of the UE) may determine to perform the RACH-less LTM cell switch procedure or the RACH-based LTM cell switch procedure based on the availability of the TA value to the target candidate cell. For example, the upper layer (e.g., MAC layer) may follow the flowchart 900 as introduced in FIG. 9. For example, when the UE has a valid TA value received from the gNB, the UE may apply the TA value and the RACH-less LTM cell switch procedure is performed (and no RA procedure is required). In this case, the RRC layer may be informed (e.g., by MAC layer) that the RA procedure is not required. For example, when the UE does not have a valid TA value received from the gNB but the UE has a valid TA value measured by itself (when the UE is configured to measure the TA value by itself), the UE may apply the measured TA value and the RACH-less LTM cell switch procedure is performed. In this case, the RRC layer may be informed (e.g., by the MAC layer) that the RA procedure is not required. In another example, when the UE does not have any valid TA value, the UE may perform the RACH-based LTM cell switch procedure accordingly. In this case, the RRC layer may be informed (e.g., by the MAC layer) that the RA procedure is required. In one implementation, the upper layer (e.g., the RRC layer) may inform/notify the lower layer (e.g., the MAC layer) whether the UE is configured with UE-based TA measurements such that the RACH-less LTM cell switch procedure may be performed by using its calculated/measured TA to synchronize with a target candidate cell. It should be noted that the UE may evaluate whether the execution condition(s) of the LTM candidate configuration is fulfilled when the execution condition(s) of the LTM candidate configuration is valid, active, enabled or configured.

In one implementation, a lower layer (e.g., the MAC layer) may inform or notify an upper layer (e.g., the RRC layer) that the LTM cell switch procedure is triggered (or successfully completed) and/or information related to the triggered conditional LTM candidate configuration (e.g., the associated target configuration ID). In one implementation, a lower layer (e.g., the MAC layer) may inform/notify an upper layer (e.g., the RRC layer) that the LTM cell switch procedure is triggered (or successfully completed) due to the conditional LTM and/or information related to the triggered conditional LTM candidate configuration (e.g., the associated target configuration ID). In one implementation, a lower layer (e.g., the MAC layer) may inform or notify an upper layer (e.g., the RRC layer) that the LTM cell switch procedure is triggered due to the conditional LTM and the RA procedure is required. In one implementation, a lower layer (e.g., the MAC layer) may inform or notify an upper layer (e.g., the RRC layer) that the LTM cell switch procedure is triggered and whether the RA procedure is not required. In one implementation, upon receiving the notification/information from the lower layer (e.g., the MAC layer), the upper layer (e.g., the RRC layer) may apply the target candidate cell configuration (in the conditional LTM candidate configuration). In one implementation, upon receiving the notification from the lower layer, the upper layer may generate the conditional LTM execution notification message based on the information received from the lower layer and instruct lower layer to transmit the message and/or wait for the cell switch command from the gNB. Upon transmitting the conditional LTM execution notification message, a response timer T5 starts. When the response timer T5 expires and no cell switch command is received, the UE (or the RRC layer of the UE) may directly apply the target candidate cell configuration (in the conditional LTM candidate configuration).

In one implementation, when the execution condition(s) of more than one conditional LTM candidate configuration is fulfilled (e.g., based on the L1 measurements), a lower layer (e.g., the PHY layer) may inform/notify an upper layer (e.g., the MAC layer) the information of each satisfied conditional LTM candidate configuration (e.g., by providing the associated target configuration ID). In one implementation, when the execution condition(s) of more than one conditional LTM candidate configuration is fulfilled (e.g., based on the L1 measurements), a lower layer (e.g., the PHY layer) may inform/notify an upper layer (e.g., the MAC layer) the information of one selected conditional LTM candidate configuration (e.g., by providing the associated target configuration ID).

In one implementation, when a lower layer (e.g., the PHY layer or the MAC layer) informs/notifies an upper layer (e.g., the MAC layer or the RRC layer) the information of more than one satisfied conditional LTM candidate configuration, the upper layer may (randomly) select one satisfied conditional LTM to perform the LTM cell switch procedure (e.g., either the RACH-less LTM cell switch procedure or the RACH-based LTM cell switch procedure). In one implementation, when a lower layer (e.g., the PHY layer) informs/notifies an upper layer (e.g., the MAC layer or the RRC layer) the information of more than one satisfied conditional LTM candidate configuration, the upper layer may select one satisfied conditional LTM with the highest priority to perform the LTM cell switch procedure. When there is more than one satisfied conditional LTM candidate configuration with the same highest priority value, the UE may randomly select one satisfied conditional LTM candidate configuration.

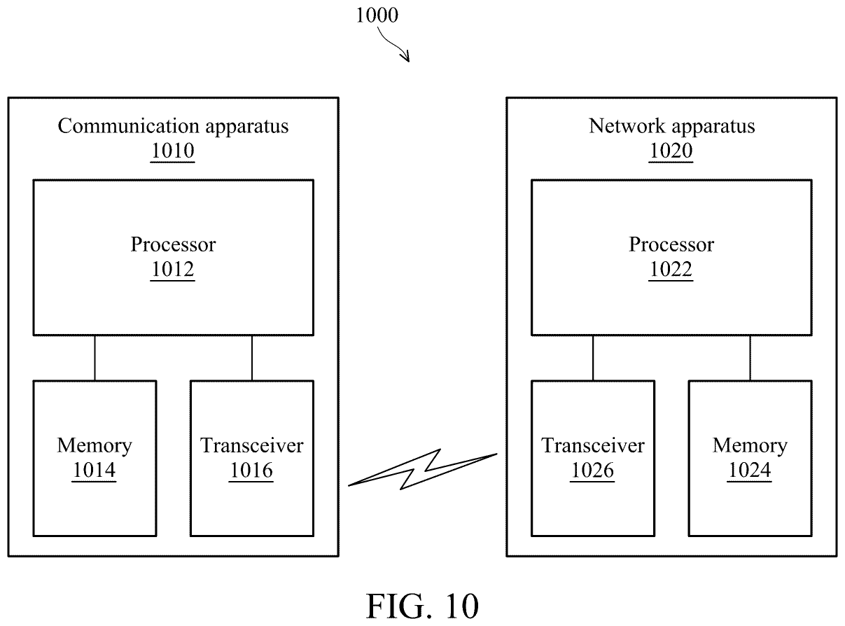

FIG. 10 illustrates an example communication system 1000 having an example communication apparatus 1010 and an example network apparatus 1020 in accordance with an implementation of the present disclosure. Each of communication apparatus 1010 and network apparatus 1020 may perform various functions to implement schemes, techniques, processes and methods described herein pertaining to configuration of conditional LTM procedure, including scenarios/schemes described above as well as process 1100 described below.

The communication apparatus 1010 may be a part of an electronic apparatus, which may be a UE such as a portable or mobile apparatus, a wearable apparatus, a wireless communication apparatus or a computing apparatus. For instance, the communication apparatus 1010 may be implemented in a smartphone, a smartwatch, a personal digital assistant, a digital camera, or computing equipment such as a tablet computer, a laptop computer or a notebook computer. The communication apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 1010 may be implemented in a smart thermostat, a smart fridge, a smart door lock, a wireless speaker or a home control center. Alternatively, the communication apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 1010 may include at least some of those components shown in FIG. 10 such as a processor 1012, for example. The communication apparatus 1010 may further include one or more other components not pertinent to the proposed scheme of the present disclosure (e.g., internal power supply, display device and/or user interface device), and, thus, such component(s) of the communication apparatus 1010 are neither shown in FIG. 10 nor described below in the interest of simplicity and brevity.

The network apparatus 1020 may be a part of an electronic apparatus, which may be a network node such as a BS, a small cell, a router or a gateway. For instance, the network apparatus 1020 may be implemented in a gNB in a 5G, B5G, 6G, IoT, NB-IoT or IIoT network. Alternatively, the network apparatus 1020 may be implemented in the form of one or more IC chips such as, for example and without limitation, one or more single-core processors, one or more multi-core processors, or one or more RISC or CISC processors. The network apparatus 1020 may include at least some of those components shown in FIG. 10 such as a processor 1022, for example. The network apparatus 1020 may further include one or more other components not pertinent to the proposed scheme of the present disclosure (e.g., internal power supply, display device and/or user interface device), and, thus, such component(s) of the network apparatus 1020 are neither shown in FIG. 10 nor described below in the interest of simplicity and brevity.

In one aspect, each of the processor 1012 and the processor 1022 may be implemented in the form of one or more single-core processors, one or more multi-core processors, or one or more CISC processors. That is, even though a singular term “a processor” is used herein to refer to the processor 1012 and the processor 1022, each of the processor 1012 and the processor 1022 may include multiple processors in some implementations and a single processor in other implementations in accordance with the present disclosure. In another aspect, each of the processor 1012 and the processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 1012 and the processor 1022 is a special-purpose machine specifically designed, arranged and configured to perform specific tasks including configuration of conditional LTM procedure in a UE (e.g., as represented by the communication apparatus 1010) and a gNB (e.g., as represented by the network apparatus 1020) in accordance with various implementations of the present disclosure.

In some implementations, the communication apparatus 1010 may also include a transceiver 1016 coupled to the processor 1012 and capable of wirelessly transmitting and receiving control and data signals. In some implementations, the transceiver 1016 may be capable of wirelessly communicating with different types of gNBs of different RATs. In some implementations, the transceiver 1016 may be equipped with a plurality of antenna ports (not shown) such as, for example, four antenna ports. That is, the transceiver 1016 may be equipped with multiple transmit antennas and multiple receive antennas for multiple-input multiple-output (MIMO) wireless communications. In some implementations, the network apparatus 1020 may also include a transceiver 1026 coupled to the processor 1022 and capable of wirelessly transmitting and receiving control and data signals. In some implementations, the transceiver 1026 may be capable of wirelessly communicating with different types of UEs of different RATs. In some implementations, the transceiver 1026 may be equipped with a plurality of antenna ports (not shown) such as, for example, four antenna ports. That is, the transceiver 1026 may be equipped with multiple transmit antennas and multiple receive antennas for MIMO wireless communications. Accordingly, the communication apparatus 1010 and the network apparatus 1020 may wirelessly communicate with each other via the transceiver 1016 and transceiver 1026, respectively.

In some implementations, the communication apparatus 1010 may further include a memory 1014 coupled to the processor 1012 and capable of being accessed by processor 1012 and storing data therein. In some implementations, the network apparatus 1020 may further include a memory 1024 coupled to the processor 1022 and capable of being accessed by the processor 1022 and storing data therein. Each of the memory 1014 and the memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of the memory 1014 and the memory 1024 may include a type of non-volatile random-access memory (NVRAM) such as flash memory, solid-state memory, ferroelectric RAM (FeRAM), magnetoresistive RAM (MRAM) and/or phase-change memory.

Each of the communication apparatus 1010 and the network apparatus 1020 may be a communication entity capable of communicating with each other using various proposed schemes in accordance with the present disclosure. For illustrative purposes and without limitation, a description of operations, functionalities, and capabilities of the communication apparatus 1010, implemented in or as a UE (e.g., the UE in FIGS. 3˜5), and the network apparatus 1020, implemented in or as a gNB (e.g., the gNB in FIGS. 3˜5), is provided below.

According to certain proposed schemes of the present disclosure, the processor 1012 of the communication apparatus 1010 may receive, via the transceiver 1016, a conditional LTM command from the network apparatus 1020. Specifically, the conditional LTM command includes a first target cell configuration of a first target cell and an execution condition. Then, the processor 1012 may receive, via the transceiver 1016, a first Medium Access Control (MAC) Control Element (CE) associated with the first target cell from the network apparatus 1020, wherein the first MAC CE includes Timing Advance (TA)-related information. The processor 1012 may switch to the first target cell by applying the first target cell configuration and the received TA-related information when the execution condition is fulfilled.

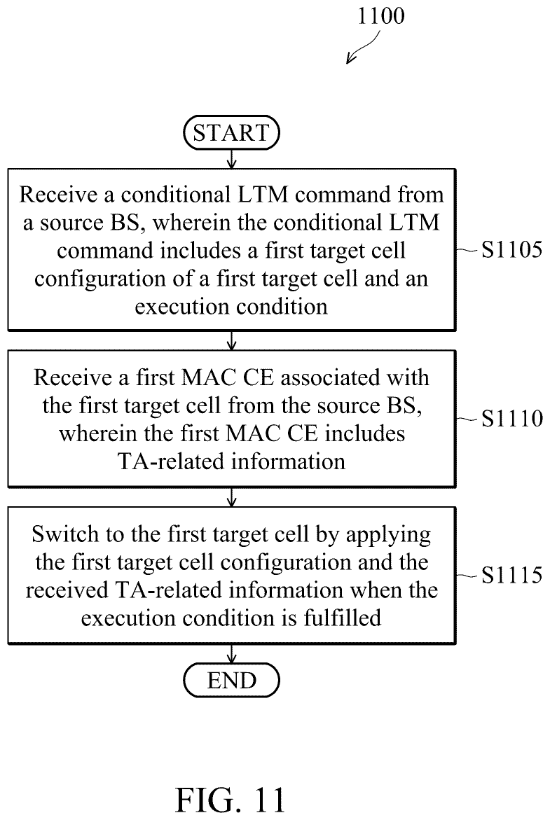

FIG. 11 illustrates an example process 1100 in accordance with an implementation of the present disclosure. The process 1100 may be an example implementation of above scenarios/schemes, whether partially or completely, with respect to conditional Layer 1/Layer 2 (L1/L2) triggered mobility (LTM) procedure. The process 1100 may represent an aspect of implementation of features of the communication apparatus 1010. The process 1100 may include one or more operations, actions, or functions as illustrated by one or more of blocks S1105, S1110 and S1115. Although illustrated as discrete blocks, various blocks of the process 1100 may be divided into additional blocks, combined into fewer blocks, or eliminated, depending on the desired implementation. Moreover, the blocks of the process 1100 may be executed in the order shown in FIG. 11 or, alternatively, in a different order. The process 1100 may be implemented by the communication apparatus 1010 or any suitable UE. Solely for illustrative purposes and without limitation, the process 1100 is described below in the context of the communication apparatus 1010 as a UE and the network apparatus 1020 as a gNB or a BS. The process 1100 may begin at block 1105.

In S1105, the process 1100 may involve the processor 1012 of the communication apparatus 1010 receiving, via the transceiver 1016, a conditional LTM command from the network apparatus 1020, wherein the conditional LTM command includes a first target cell configuration of a first target cell and an execution condition. The process 1100 may proceed from S1105 to S1110. The execution condition may be configured as either an L1 execution condition or an L3 execution condition.

In S1110, the process 1100 may involve the processor 1012 receiving, via transceiver 1016, a first Medium Access Control (MAC) Control Element (CE) associated with the first target cell from the network apparatus 1020, wherein the first MAC CE includes Timing Advance (TA)-related information. The process 900 may proceed from 1110 to 1115. In addition, the first MAC CE may include a configuration ID associated with the first target cell (or the configuration associated with the first target cell.) A time alignment timer (e.g., the timer T3) starts or restarts when the UE receives the first MAC CE associated with the first target cell (from the current serving cell or the source BS). The process 1100 may proceed from S1110 to S1115.

In S1115, the process 1100 may involve the processor 1012 switching to the first target cell by applying the first target cell configuration and the received TA-related information when the execution condition is fulfilled.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for a conditional Layer 1/Layer 2 (L1/L2) triggered mobility (LTM) procedure, wherein the method is implemented by a user equipment (UE), and comprises:
receiving a conditional LTM command from a source base station (BS), wherein the conditional LTM command includes a first target cell configuration of a first target cell and an execution condition;
receiving a first Medium Access Control (MAC) Control Element (CE) associated with the first target cell from the source BS, wherein the first MAC CE includes Timing Advance (TA)-related information; and
switching to the first target cell by applying the first target cell configuration and the received TA-related information when the execution condition is fulfilled.

2. The method for a conditional LTM procedure as claimed in claim 1, further comprising:
transmitting a capability to the source BS to indicate that at least one of:
the UE supports performing a conditional LTM procedure;
the UE supports performing a subsequent conditional LTM procedure;
the UE supports performing an L1-based conditional LTM procedure by using L1 measurements for evaluating the execution condition; and
the UE supports performing a Layer 3-based (L3-based) conditional LTM procedure by using L3 measurements for evaluating the execution condition.

3. The method for a conditional LTM procedure as claimed in claim 1, wherein upon receiving the conditional LTM command, the method further comprises:
evaluating the execution condition;
wherein the method further comprises:
stopping evaluating the execution condition once a handover procedure is executed.

4. The method for a conditional LTM procedure as claimed in claim 1, wherein when there are multiple conditional LTM commands received from the source BS and associated execution conditions of the multiple conditional LTM commands are fulfilled, the method further comprises:
randomly selecting a target conditional LTM command from the multiple conditional LTM commands and switching to a second target cell according to a second target cell configuration included in the target conditional LTM command.

5. The method for a conditional LTM procedure as claimed in claim 1, wherein the UE transmits a preamble to a first target BS of the first target cell before receiving the first MAC CE.

6. The method for a conditional LTM procedure as claimed in claim 1, wherein a timer associated with the TA-related information starts when the UE receives the first MAC CE.

7. The method for a conditional LTM procedure as claimed in claim 6, wherein the TA-related information is invalid when the timer expires.

8. The method for a conditional LTM procedure as claimed in claim 1, wherein the UE performs a random access (RA) procedure to the first target cell when the UE does not have valid TA related information.

9. The method for a conditional LTM procedure as claimed in claim 1, wherein a configuration ID associated with the first target cell is included in the first MAC CE.

10. An apparatus for a conditional Layer 1/Layer 2 (L1/L2) triggered mobility (LTM) procedure, comprising:
a transceiver which, during operation, wirelessly communicates with at least one network node; and
a processor communicatively coupled to the transceiver such that, during operation, the processor performs operations comprising:
receiving a conditional LTM command from a source base station (BS), wherein the conditional LTM command includes a first target cell configuration of a first target cell and an execution condition;
receiving a first Medium Access Control (MAC) Control Element (CE) associated with the first target cell from the source BS, wherein the first MAC CE includes Timing Advance (TA)-related information; and
switching to the first target cell by applying the first target cell configuration and the received TA-related information when the execution condition is fulfilled.

11. The apparatus for a conditional LTM procedure as claimed in claim 10, further comprising:
transmitting a capability to the source BS to indicate that at least one of:
the apparatus supports performing a conditional LTM procedure;
the apparatus supports performing a subsequent conditional LTM procedure;
the apparatus supports performing an L1-based conditional LTM procedure by using L1 measurements for evaluating the execution condition; and
the apparatus supports performing a Layer 3-based (L3-based) conditional LTM procedure by using L3 measurements for evaluating the execution condition.

12. The apparatus for a conditional LTM procedure as claimed in claim 10, wherein upon receiving the conditional LTM command, the method further comprises:
evaluating the execution condition;
wherein the method further comprises:
stopping evaluating the execution condition once a handover procedure is executed.

13. The apparatus for a conditional LTM procedure as claimed in claim 10, wherein when there are multiple conditional LTM commands received from the source BS and associated execution conditions of the multiple conditional LTM commands are fulfilled, the method further comprises:
randomly selecting a target conditional LTM command from the multiple conditional LTM commands and switching to a second target cell according to a second target cell configuration included in the target conditional LTM command.

14. The apparatus for a conditional LTM procedure as claimed in claim 10, wherein the apparatus transmits a preamble to a first target BS of the first target cell before receiving the first MAC CE.

15. The apparatus for a conditional LTM procedure as claimed in claim 10, wherein a timer associated with the TA-related information starts when the apparatus receives the first MAC CE.

16. The apparatus for a conditional LTM procedure as claimed in claim 15, wherein the TA-related information is invalid when the timer expires.

17. The apparatus for a conditional LTM procedure as claimed in claim 10, wherein the apparatus performs a random access (RA) procedure to the first target cell when the apparatus does not have valid TA related information.

18. The apparatus for a conditional LTM procedure as claimed in claim 10, wherein a configuration ID associated with the first target cell is included in the first MAC CE.

19. A method for a conditional Layer 1/Layer 2 (L1/L2) triggered mobility (LTM) procedure, wherein the method is implemented by a source base station (BS), and comprises:
transmitting a conditional LTM command to a user equipment (UE), wherein the conditional LTM command includes a first target cell configuration of a first target cell and an execution condition; and
transmitting a first Medium Access Control (MAC) Control Element (CE) associated with the first target cell to the UE, wherein the first MAC CE includes Timing Advance (TA) related information.

20. The method for conditional LTM procedure as claimed in claim 19, further comprising:
receiving a capability from the UE to indicate that at least one of:
the UE supports performing a conditional LTM procedure;
the UE supports performing a subsequent conditional LTM procedure;
the UE supports performing an L1-based conditional LTM procedure by using L1 measurements for evaluating the execution condition; and
the UE supports performing a Layer 3-based (L3-based) conditional LTM procedure by using L3 measurements for evaluating the execution condition.

21. The method for conditional LTM procedure as claimed in claim 19, wherein before transmitting the first MAC CE associated with the first target cell to the UE, the method further comprises:
receiving the TA-related information from a target base station of the first target cell.

22. The method for conditional LTM procedure as claimed in claim 19, wherein a configuration ID associated with the first target cell is included in the first MAC CE.
